(19) United States
(12) Patent Application Publication
(10) Pub. No.: US 2002/0156918 A1
(43) Pub. Date: Oct. 24, 2002

(54) Dynamic path selection with in-order delivery within sequence in a communication network

(75) Inventors: Ezio Valdevit, Redwood City, CA (US); Kreg A. Martin, Los Gatos, CA (US); David C. Banks, Pleasanton, CA (US)

Correspondence Address: WONG, CABELLO, LUTSCH, RUTHERFORD & BRUCCULERI,, P.C., 20333 SH 249, SUITE 600, HOUSTON, TX, 77070, US

(73) Assignee: Brocade Communications Systems, Inc.

(21) Appl. No.: 10/059,760

(22) Filed: Jan. 29, 2002

Related U.S. Application Data
(60) Provisional application No. 60/286,046, filed on Apr. 23, 2001.

(51) Int. Cl. G06F 15/173

(52) U.S. Cl. 709/238

(57) ABSTRACT

In a communication network system having a multi-switch Fiber Channel fabric, switches are in communication through a plurality of paths. To distribute the traffic load, more than one path can be used for any source-destination pair. However, due to limitations under the Fiber Channel standard, in-order delivery is required for certain data frames, such as those belonging to the same sequence or exchange. To avoid compromising the in-order requirement, a dynamic path selection scheme is devised. In one embodiment, a hash function is used to categorize data frames into sequences and to distribute the load in a pseudo-random manner. In another embodiment, a multiple-field routing table is used to assign arbitrary paths to different sequences.

### CROSS REFERENCE TO RELATED APPLICATIONS

The subject matter of this application is related to the subject matter of co-pending U.S. Patent Application Serial No. 60/286,046, Attorney Docket No. 4605, filed on Apr. 23, 2001, by David C. Banks, et al., entitled “Link Trunking and Measuring Link Latency in Fibre Channel Fabric” and is fully incorporated by reference herein.

### BACKGROUND OF INVENTION

This application relates generally to routing data traffic within a communication network system, and more particularly to managing and selecting data flow paths amongst switching devices within the communication network system.

Background of the Technical Field

As used herein, the term “Fibre Channel” refers to the Fibre Channel family of standards (developed by the American National Standards Institute (ANSI)). In general, Fibre Channel defines a transmission medium based on a high speed communications interface for the transfer of large amounts of data via connections between a variety of hardware devices, including devices such as personal computers, workstations, mainframes, supercomputers and storage devices. Use of Fibre Channel is proliferating in many applications, particularly client/server applications which demand high bandwidth and low latency input/output (I/O). Examples of such applications include mass storage, medical and scientific imaging, multimedia communications, transaction processing, distributed computing and distributed database processing applications.

In one aspect of the Fibre Channel standard, the communication between devices is facilitated over a fabric. The fabric is typically constructed from one or more Fibre Channel switches and each device (or group of devices, for example, in the case of loops) is coupled to the fabric. Devices coupled to the fabric are capable of communicating with every other device coupled to the fabric.

When a communication network system includes a multi-switch Fibre Channel fabric, switches are typically coupled together by connecting their respective E_Ports to create the fabric and to enable frames to be carried between switches in-order to configure and maintain the fabric. An E_Port on one (i.e., local) switch is a fabric expansion port which is communicatively coupled to another E_Port on a corresponding (i.e., remote) switch to create an Inter-Switch link (ISL) between adjacent switches. Frames with a destination, other than local to a switch or any other types of ports (i.e., N_Port or NL_Port) coupled to the local switch, exit the local switch passing through the E_Port. By contrast, frames that enter a switch through an E_Port travel to a destination local to the switch or to other destinations through another E_Port. Amongst the switches, the ISLs generally carry frames originating from a node port as well as those frames which are generated within the fabric. Additionally, ISLs are conventionally used by switches to transmit and receive frames amongst switches within the fabric, and will be understood by those skilled in the art to be point-to-point links between switches.

Due to limitations imposed by certain Fibre Channel protocol devices and to improve performance, frame traffic between a source device and a destination device is very preferably delivered “in-order” within an exchange. This effective requirement for “in-order” delivery often results in frame routing techniques that entail fixed routing paths within a fabric. Although such fixed routes guarantee that all frames between source and destination ports are delivered “in-order,” at least in the absence of topology changes internal to the fabric, the fixed routing paths are problematic for several reasons.

Firstly, certain traffic patterns in a fabric may cause all active routes to be allocated to certain available path(s), thereby creating a high probability for congestion through such available path(s). Given more than one path between a source device and a destination device, a portion of the traffic would be allocated to each possible path. Consider “streams” of data traffic between a single source and destination port pair. In certain combinations of streams that are active, the traffic load would be evenly distributed across the available paths, and the optimum performance (given the fabric topology) would be realized. If, however, a different collection of streams happened to be running simultaneously, a drawback arises in that all of the active streams can be allocated to a single one of the available paths, and the remaining paths would be unused. This results in a performance bottleneck if the aggregation of the streams exceeded the capacity of any of the ISLs forming the path between source and destination ports.

Secondly, having traffic routed through a single available path or only certain ones of all available paths results in system inefficiency because other paths become underutilized.

Thirdly, the bandwidth of traffic flow is limited if only one path is or only a few paths are relied upon. It is noted that as the result of continuous advances in technology, particularly in the area of networking such as the Internet, there is an increasing demand for communications bandwidth. For example, there are many applications that require the high speed transmission of large amounts of data, including the transmission of images or video over the Internet, the transaction processing and video-conferencing implemented over a public telephone network, and the transmission of data over a telephone company's trunk lines. For these types of data intensive-applications to be implemented at a high rate of data transfer, high bandwidth is desirable.

What is needed is a manner in which: (1) to alleviate frame traffic congestion along particular paths; (2) to enable frame traffic to be distributed across available paths so that no paths are under-utilized; and (3) to improve the communications bandwidth through the fabric, all the while maintaining “in-order” delivery of frames.

### SUMMARY OF INVENTION

The present invention includes a computer-implemented method, system and computer medium and other embodiments for distributing traffic load through dynamic path selection in a communication network while guaranteeing in-order delivery within sequence. One embodiment of the process involves the use of appropriate header information to categorize data frames, as each of them is received, into sequences that require in-order delivery. Each sequence is then associated with a path through which all data frames within the sequence will take to reach the destination, thus preserving the order of frames within the sequence.

The selection of an appropriate path may involve the predetermination of a set of possible paths between each given source-destination pair based on specified criteria. The predetermined set of paths can be associated with an entry to a multiple field routing table, each path being associated with at least one field. The resulting routing table can be used to route all data frames.

The header information can be utilized in the calculation of a hash function on a frame-by-frame basis. Based on the calculated hash function, one path is selected out of the predetermined set of paths to the destination. Because the hash function yields arbitrary, pseudo-random numbers, the data traffic is evenly distributed among the predetermined set of paths in a statistical sense.

Advantages of the invention will be set forth in part in the description which follows and in part will be apparent from the description or may be learned by practice of the invention. The objects and advantages of the invention will be realized and attained by means of the elements and combinations particularly pointed out in the appended claims and equivalents.

### BRIEF DESCRIPTION OF DRAWINGS

FIG. 1 is a block diagram of a communication network system having a Fibre Channel fabric.

FIG. 2 is a detailed block diagram illustrating a multi-switch Fibre Channel fabric, which is an embodiment of the Fibre Channel fabric of FIG. 1.

FIG. 3A is a block diagram illustrating conventional load sharing in a multi-switch Fibre Channel fabric.

FIG. 3B is a block diagram illustrating dynamic path selection in a multi-switch Fibre Channel fabric according to one embodiment of the present invention.

FIG. 4 is a detailed block diagram illustrating the data flow and logical control within a switch in one embodiment of the present invention.

FIG. 5A is an illustration of a conventional routing table used in a multi-switch Fibre Channel fabric.

FIG. 5B is an illustration of a multiple-field routing table included in the embodiment of FIG. 4.

FIG. 6 is a flowchart showing an embodiment for dynamic path selection with in-order delivery within sequence.

FIG. 7A is an illustration of the fields in the header of a data frame.

FIG. 7B illustrates an example of a chart matching the results of hash function calculation to local transmit ports corresponding to a set of paths, according to one embodiment of the present invention.

FIG. 8A is a block diagram illustrating dynamic path selection in a multi-switch Fibre Channel fabric including path weighting according to one embodiment of the present invention.

FIG. 8B illustrate an example multiple-field routing table entry corresponding to the embodiment of FIG. 8A.

### DETAILED DESCRIPTION

A system, method, computer medium and other embodiments for dynamic path selection with in-order delivery within sequence in communication network including a Fibre Channel fabric are described. In the following description, for purposes of explanation, numerous specific details are set forth in-order to provide a thorough understanding of the invention. It will be apparent, however, to one skilled in the art that the invention can be practiced without these specific details. In other instances, structures and devices are shown in block diagram form in-order to avoid obscuring the invention.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It has proven convenient at times, principally for reasons of common usage, to refer to these signals as bits, values, elements, symbols, characters, terms, numbers, or the like. Furthermore, it has also proven convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

The present invention is well-suited to a wide variety of computer network systems over numerous topologies, including storage area networking (SAN) systems. Within this field, the configuration and management of large networks comprise storage devices and computers that are communicatively coupled to dissimilar computers and storage devices over a Fibre Channel infrastructure.

Reference will now be made in detail to several described embodiments of the present invention, examples of which are illustrated in the accompanying drawings. Wherever practicable, the same reference numbers will be used throughout the drawings to refer to the same or like parts.

A. Multi-Switch Fibre Channel Communication Network System

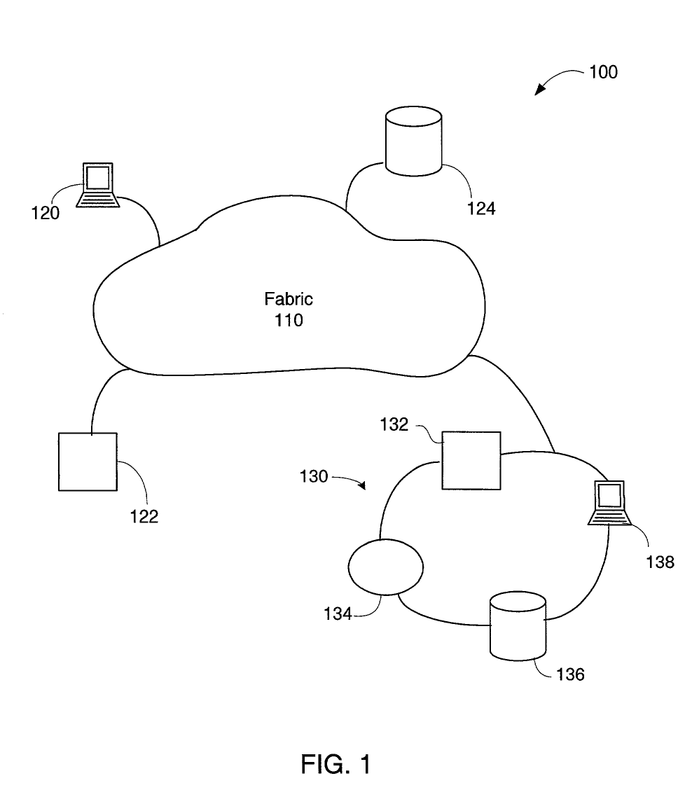

FIG. 1 is a block diagram of an embodiment of a Fibre Channel communication network system 100 that may beneficially utilize the present invention, and may contain an embodiment of the process steps and modules of the present invention in the form of one or more computer programs. Alternatively, the process steps and modules of the present invention could be embodied in firmware or hardware, and when embodied in software, could be downloaded to reside on and be operated from different platforms used by real-time network operating systems. The process steps of the present invention entail the dynamic path selection with in-order delivery within sequence in a Fibre Channel communication network such as system 100.

The Fibre Channel communication network system 100 comprises a fabric 110, and a plurality of devices 120, 122, 124, and/or groups of devices 132, 134, 136 and 138 as indicated with respect to loop 130. In general, fabric 110 is coupled to the various devices 120, 122, and 124, and acts as a switching network to allow the devices to communicate with each other. Devices 120, 122, 124 may be any type of device, such as a computer or a peripheral, and are coupled to the fabric 110 using point-to-point topology. Fabric 110 is also in communication with logical loop 130. Loop 130 includes devices 132, 134, 136 and 138, which help to form loop 130. In one embodiment, the loop 130 comprises an arbitrated loop with ring connections for providing multiple nodes with the ability to arbitrate access to a shared bandwidth.

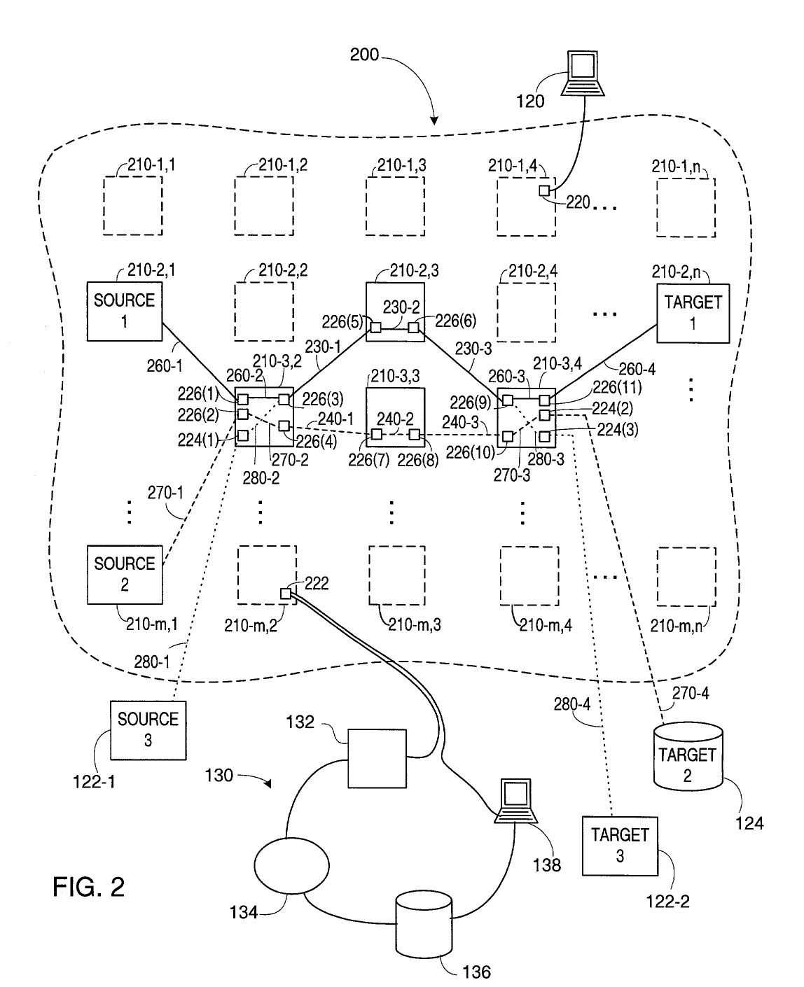

In the described embodiments to follow, fabric 110 can embody a Fibre Channel network 200 (also referred to herein interchangeably as “fabric 200”) made up of one or more interconnected Fibre Channel switches 210-1,1 through 210-n,n, shown in the detailed block diagram of FIG. 2. However, it is noted, that the invention is not limited to such fabrics or to Fibre Channel. Switches 210-1,1 through 210-n,n, although possibly configured in a variety of manners so long as consistent with the Fibre Channel standard, will be generically referred to as “switch 210” for the purpose of general discussion herein. As illustrated, several switches 210 are depicted as dashed-boxes to indicate the potential breadth of the Fibre Channel network without loss of generality. Although not shown explicitly in detail, each switch 210 is coupled to another switch or device, similar to those connections explicitly shown and as understood by those skilled in the art. Within each switch 210, different types of ports support different types of connections from devices to a switch. For example, an F_Port 220 is a label used to identify a port of a fabric 200 that directly couples the fabric 200 to a single device 120, such as a computer or peripheral. An FL_Port 222 is a label of a port used to identify a port of a fabric that couples the fabric 200 to loop 130. An F_Port 224 is a label used to couple a device (e.g., 122, 124) to the fabric 200. For the present invention, the most relevant ports on switches 210, are the E_Ports 226(x), where x=1, 2, . . . , 11, by way of example, as illustrated in FIG. 2. The function of an E_Port has been described previously. In general, switches 210 use the destination identifier or D_ID (e.g., 24 bit) in received frames to make routing decisions. Routing tables are contained in the receiving switch hardware, allowing uni- and multi-cast routes to be set up independently per receive port, but embodiments according to the present invention could be utilized with a centralized routing table structure as well.

It is understood that the examples discussed herein are purely illustrative. For example, referring back to FIG. 1, fabric 110 may comprise a single switch or a large number of switches. Exemplary switches that are well-suited for use with the present invention include those manufactured by Brocade Communication Systems, Inc. These and other comparable switches enable server computers to be communicatively coupled with storage devices through a SAN system, creating a reliable, highly available, and scalable environment for storage applications. Each switch comprises ports to which devices may be coupled thereto. In one embodiment, these ports are implemented on ASICs (used interchangeably with “chip”) that may be affixed to hardware components (e.g., circuit boards and modules accommodating ICs), which may be plugged into or removed from a switch. Additionally, universal ports that are compatible with a variety of port types (e.g., E_Ports, F_Ports, FL_Ports) may be included within each switch 210. The composition and configuration of switches 210 and devices shown in FIG. 2 are merely illustrative. Other port combinations could be used to couple the switches together to form fabrics 110 and 200. As will be readily appreciated by those skilled in the art of Fibre Channel, each switch 210 includes a copy of the information defining configurations. Since each switch maintains its own copy of the configuration information, a single switch failure will not necessarily interrupt communication amongst other devices within the fabric.

B. Path Management and Load Sharing in Fibre Channel Fabric

As seen in FIG. 2, switch 210-3,2 includes four E_Ports, ports 226(1), 226(2), 226(3) and 226(4)), while switches 210-2,3 and 210-3,3 each has two E_Ports, ports 226(5) and 226(6) and ports (226(7) and 226(8), respectively, and switch 210-3,3 includes three E_Ports, ports 226(9), 226(10) and 226(11). In addition, switch 210-3,2 has one F_Port, port 224(1) and switch 210-3,4 has two F_Ports, ports 224(2) and 224(3), coupling fabric 200 to devices 122-1 and 122-2 and database 124, respectively. The various E_Ports are communicatively coupled to other E_Ports, as seen in FIG. 2. For the present invention, it is important to note those communication links constituting the two paths connecting switch 210-3,2 and switch 210-3,4, namely, path 230, consisting of links 230-1, 230-2 and 230-3, going through switch 210-2,3, and path 240, consisting of links 240-1, 240-2 and 240-3, going through switch 210-3,3.

Frames from sources comprising switch 210-2,1 (“source 1”), switch 210-n,1 (“source 2”) and device 122-1 (“source 3”) pass through switches 210-3,2 and 210-3,4 to reach their final respective destinations, namely switch 210-2,n (“target 1”), database server 124 (“target 2”), and device 122-2 (“target 3”). It will be apparent to those skilled in the art that either of the two paths 230 and 240 described above connecting switches 210-3,2 and 210-3,4 may be used, subject to other considerations, e.g. cost for using switch 210-2,3 versus that for switch 210-3,3. Note also that, although sources 1-3 have been described in the context of having originating frames to be transmitted to destinations, it will be appreciated by those skilled in the art that sources 1-3 may themselves be destinations relative to other source devices.

As shown by solid lines, frames originating from source 1 and destined for target 1 are routed through the path 260-1, 260-2, 230-1, 230-2, 230-3, 260-3, and 260-4 since path 230 is available. As also shown in dashed lines, frames originating from source 2 and destined for target 2 are routed through the path 270-1, 270-2, 240-1, 240-2, 240-3, 270-3, and 270-4; the reason for this route may be predetermined or may be based on path 240 being available and path 230 being busy.

When source 3 begins to communicate with target 3 through switches 210-3,2 and 210-3,4, congestion may occur. In one situation, if path 240 were to become inoperative (e.g., through hardware failure), frames originating from source 3 and destined for target 3 are routed through the path 280-1, 280-2, 230-1, 230-2, 230-3, 280-3, and 280-4, as shown in dotted lines. In another situation, congestion might occur even when path 240 is operational and there is no issue of inoperative hardware being present. To illustrate, assume the following: source 1 uses path 230 to reach target 1; source 2 uses path 240 to reach target 2; and source 3 uses path 230 to reach target 3. Without the use of dynamic path selection according to the present invention, the use of paths 230, 240 is fixed in-order to ensure in-order delivery of frames. Congestion will arise where the path from source 1 to target 1 and the path from source 3 to target 3 are both active, and attempting transmission is undertaken at a rate which exceeds that of a single path 230. Essentially, transmission along path 230 will be throttled by the rate at which ISLs 230-1 and 230-3 can transfer frames, thereby potentially resulting in congestion over path 230. Moreover, this congestion will occur even if there is no traffic from source 2 to target 2 in progress at the same time.

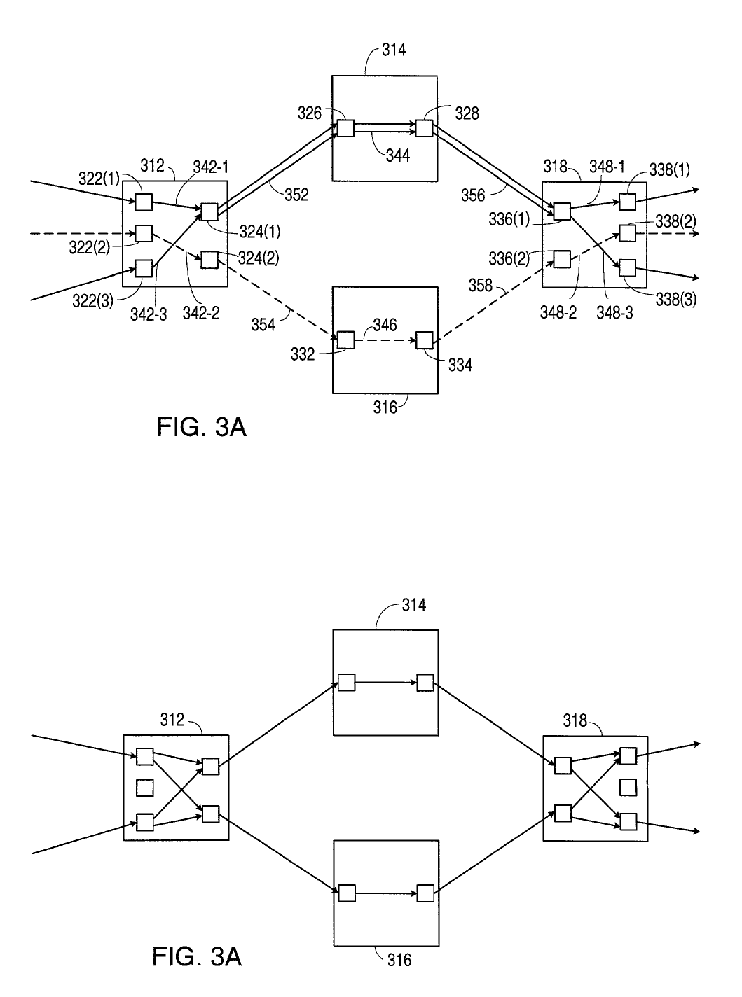

The above example is further illustrated in FIG. 3A. As shown, switches 312, 314, 316 and 318 are analogous to the Fibre Channel switches 210-3,2, 210-2,3, 210-3,3 and 210-3,4 in FIG. 2, respectively. The various ports 322(1), 322(2), 322(3), 324(1), 324(2), 326, 328, 332, 334, 336(1), 336(2), 338(1), 338(2) and 338(3) also correspond to analogous ports shown in FIG. 2 as discussed in the example above. Two paths are shown from switch 312 to switch 318, going through either switch 314 and the corresponding ISLs 352 and 356 or switch 316 and the ISLs 354 and 358. Data flows are illustrated in FIG. 3A by arrowed lines, whereas unused paths are shown as dashed lines. This example helps illustrate the conventional, static load sharing scheme, which has been used to statically match the three ports 322 to the two ports 324 in switch 312, at least while all ports and links involved are operational. Two ports 322(1) and 322(3) are matched to port 324(1) and the remaining port 322(2) to port 324(2), perhaps because the path through port 324(1) has more capacity, or because more traffic goes through port 322(2). In the unfortunate case illustrated in FIG. 3A, when traffic comes in through ports 322(1) and 322(3) but not port 322(2), all traffic travels through the same path 352, 344, 356 to switch 318, while the other possible path 354, 346, 358 is left idling.

C. An Overview of Dynamic Load Sharing in Fibre Channel Fabric

FIG. 3B illustrates an embodiment of dynamic path selection, using as example the same incoming data flows as assumed in FIG. 3A. The same switches and ports are shown in FIGS. 3A and 3B. The only significant difference between the situation in FIG. 3B and that in FIG. 3A is that the internal path for data flow from each port within switch 312 is not “hard wired” but rather consists of a set of possible paths. The result, in this case, is that the traffic is spread evenly between all possible paths and the congestion problem shown in FIG. 3A is alleviated. The set of possible paths in the present example corresponds to a set of internal data paths within the local switch 312, which in turns correspond to both ports. However, it will be appreciated by one skilled in the art, that a subset of all ports may be included. Also, each port in this example corresponds to a completely separate path from the first switch to the last. One skilled in the art will recognize that the set of paths may overlap partially over certain ISLs. These paths may have been selected based on link capacities and/or the cost to use particular switches in the fabric.

One technical advantage of the present invention is that there is no requirement to use specialized optical or copper ribbon cables and unusual connectors between switches in-order to achieve the desired functionality. The algorithm for distributing the data frames over multiple possible paths can be included in the routing logic of the ingress port, which carries out a frame-by-frame determination to select one of the possible paths for each data frame. The process steps for this algorithm are discussed in detail in the next section. What follows is an illustration of a switch implemented with the routing logic according to an embodiment of the present invention.

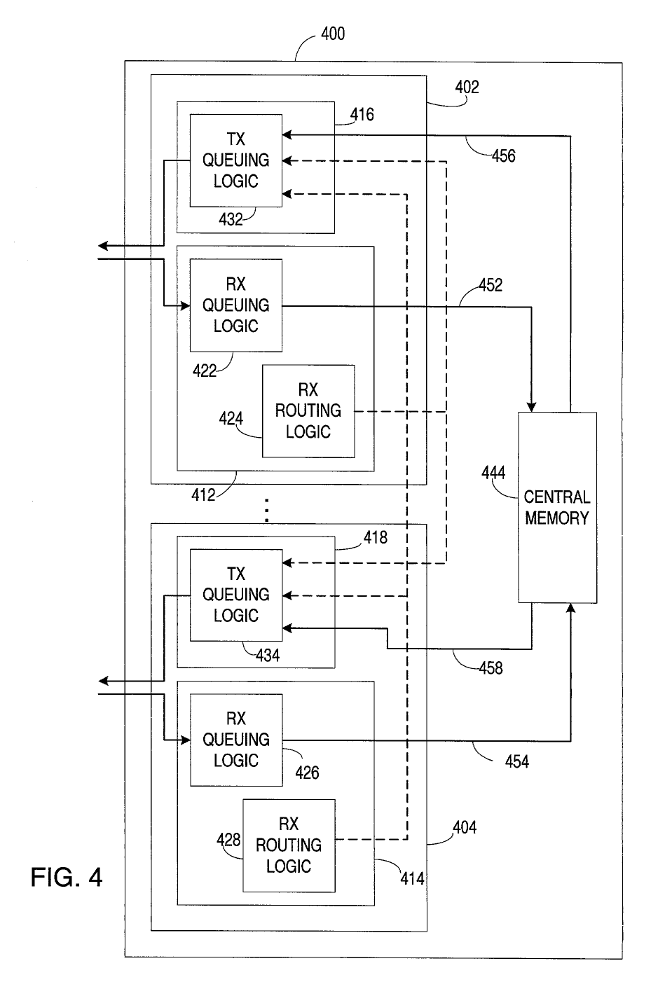

FIG. 4 depicts a block diagram illustrating switch 400, which works suitably well with the described embodiments of the present invention to overcome the drawbacks associated with conventional static path routing of frames and to perform the load sharing optimizations in accordance with the present invention. For illustrative purposes, switch is shown with four E_Ports, namely 402 and 404. Each E_Port 402 and 404 includes an egress or transmit portion 426, 418 and an ingress or receive portion 412, 414. It will be apparent to those skilled in the art that any number of E_Ports may reside on a switch as determined by the hardware constraints of the particular switch. It will be apparent to one skilled in the art that switch 400 is interchangeable with switch 312 in FIGS. 3A and 3B, although one less port is shown.

In FIG. 4, each receive portion 412, 414 includes a receive queuing logic module 422, 426 and a routing logic module 424, 428. Each transmit portion 416, 418 also includes a transmit queuing logic module 432, 434. The receive queuing logic modules 426, 428 receive data frames from their sources, store them into the central memory 440, from which they are retrieved to the appropriate transmit queuing logic modules 432, 434 for transmission to another switch. Determining to which port a particular data frame should go is a function of the routing logic module 424, 428. In one embodiment of the present invention, the routing logic module 424, 428 comprises a multiple-field routing table, to be described further in the next section. In one embodiment, the routing logic module 424, 428 is in communication with the ports to which it may send frames, as indicated in FIG. 4 by dashed lines. Based on the multiple-field routing table and the entries established at initiation of the switch 400, the routing logic module 424, 428 decides for each frame which path to take, and therefore the port to use, and directs the central memory to send the frame through the appropriate internal data path, either path 456 or path 458 in this example.

In general, dynamic path selection with in-order delivery within sequence treats a group of paths as a logical pipe. By doing so, frames received at one switch may be transmitted to a remote switch after being dispensed over a predetermined set of possible paths, so that the probabilities of congestion over particular paths and of underutilized paths are minimized. Dynamic path selection according to the present invention is beneficial for a number of reasons. For example, it enables frame traffic to be nearly evenly distributed across available paths while preserving in-order delivery. While one aspect of the present invention is to establish as large a pipe as possible based on hardware constraints so as to improve communication bandwidth, it is a further object to guarantee “in-order” delivery of frames traveling over the set of possible paths. To do both, it is essential that certain routing logic be built into the RX ports when a switch is initialized with respect to the fabric.

Although not shown in FIG. 4, each switch 400 also includes a central processing unit (CPU) module which controls the initialization of the switch. The CPU module typically includes some sort of processor used with a local memory module 440. As an example of the initialization of switch 400, the CPU module provides support to its associated switch, i.e., switches it may communicate with directly or indirectly, for operating a Simple Name Server (SNS). The SNS in a fabric provides address information to devices about other devices connected to the fabric. It will be readily recognized by those skilled in the art that, as part of the Fibre Channel standard, ports joining a fabric typically must register their Fibre Channel attributes with the SNS. The switches also typically query the SNS for address information and attributes of other devices (e.g., other N_Ports, NL_Ports) on the fabric. In response, the SNS provides an address list of other devices on the fabric. If address information changes at a later time, the fabric sends a change signal to each device to instruct it to re-query the SNS for updated address information. Once the switches are initialized, the CPU module is generally not necessary for the operation of the switch 400.

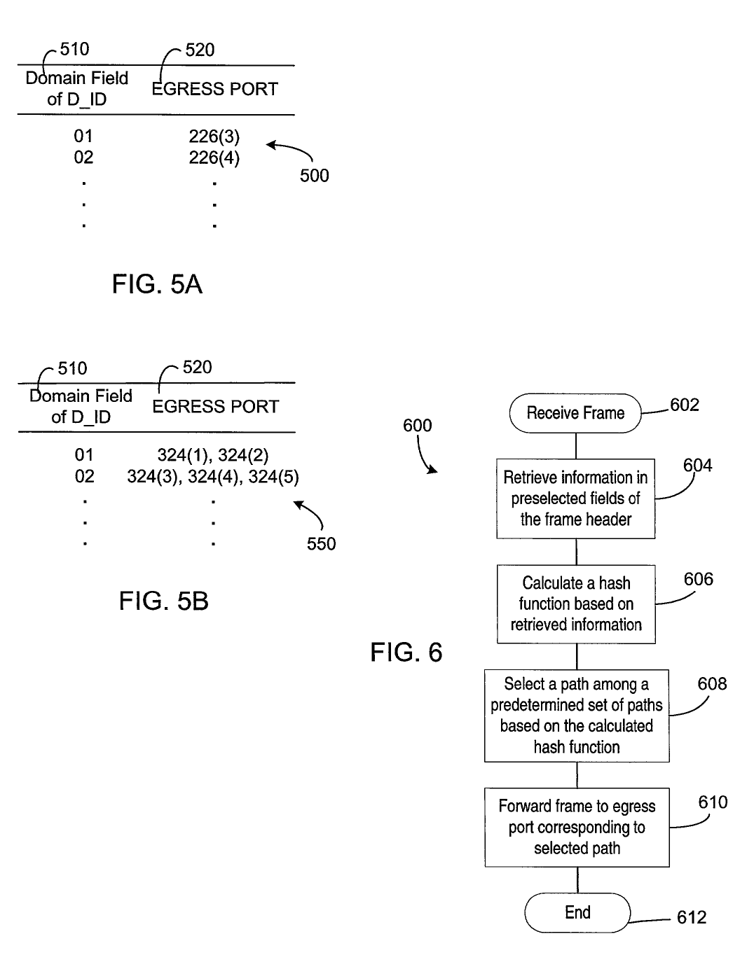

During fabric initialization, the present invention enables the selection of a set of possible paths for each destination based on the information received from the SNS. This may be accomplished through a firmware-driven process referred to as Fabric Shortest Path First (FSPF), the preferred path selection protocol. Each switch then sets up its internal routing tables and the receive and transmit queuing logic modules 422, 426, 432 and 434 that reflects the choice of the set of paths. Conventionally, the domain field of the destination identifier (D_ID) is used as the index in a routing table, so that a path to a remote domain is associated with each domain field, as shown in FIG. 5A. As illustrated in FIG. 5A, each entry to routing table 500 matches a destination domain, as designated by the domain field of its D_ID in field 510, with a port in field 520. The example shown in FIG. 5A corresponds to a situation depicted in FIG. 2, in which frames entering switch 210-3,2 and destined for target 1, shown here as having a D_ID domain field of 01, would be forwarded to port 226(3), whereas those frames destined for target 2, shown here as having a D_ID domain field of 02, would be forwarded to port 226(4). One skilled in the art will recognize that the actual notations for the ports within the routing table are likely to be different from the likes of “226(1),” which form is used here only for illustration purposes.

In the present invention, the routing table of each port in the switch is set up to send frames, destined for a particular destination, through multiple paths. FIG. 5B illustrates a “multiple-field” routing table 550, wherein the egress port field 520 of FIG. 5A is replaced with multiple fields 525. The multiple fields 525 correspond to the multiple ports in the local switch that lead to the predetermined paths, the selection of which has been discussed above. Since each port can be used, a frame will have a choice of paths as it enters the switch. Note that, according to the exemplary numbers shown in the routing table 550 of FIG. 5B, a frame entering switch 312 of FIG. 3B having a D_ID domain field of 01 may use one of the two paths shown in that figure, the two paths both originating at ports 324(1) and 324(2), by way of example. Similarly, the other entry to the routing table 550 may allow another frame with a different D_ID domain field to use any of the three ports listed under fields 525, although those ports are not shown in FIG. 3B. Again, note that the actual notation of the ports in the routing table may be different that what are shown here for illustration purposes. As frames are received from other switches or devices an entry to the routing table is identified for each frame based on its Dm_D. Each port listed for that entry under multiple fields 525 might be chosen, to which the frame will be forwarded. In the preferred embodiment, the ports listed in the multiple fields 525 should have similar chances of being chosen.

Another aspect of the present invention is the guarantee of in-order delivery within sequence, which requires the routing logic modules 424, 428 to first distinguish a sequence from another. The word “sequence” is used here to stand for a stream of data frames between a source and a destination device having certain common quality or requirements. For example, a sequence may be a Fibre Channel exchange, which is a Fibre Channel construct that is used by both SCSI and IP running over Fibre Channel. In SCSI, a Fibre Channel exchange generally corresponds to a single input/output (I/O) operation (e.g., a disk read or write). To recognize a sequence, the routing logic may include the use of the header information in each data frame. For example, all data with the same exchange identifiers may be considered a sequence. In that case the originator exchange identifier (OX_ID) and responder exchange identifier (RX_ID) field in the header must be examined for each data frame to determine the sequence to which the frame belongs.

Different applications may have different requirements on in-order delivery. The particular header fields used to distinguish “sequences” should therefore be tailored to the need for in-order delivery at the initialization of the switch. For example, in addition to the OX_ID and RX_ID fields mentioned above, the destination identifier (D_ID) and the source identifier (S_ID) are often useful in recognizing sequences. It will be appreciated by one skilled in the art that the more fields are included, the smaller the resulting sequences. Also, selective fields may be masked off when performing the frame-by-frame analysis discussed in the next section. This may be desirable for reason of time and cost savings. However, as more fields are excluded from the analysis, the ability to distribute traffic across available paths becomes more restricted.

Conventionally, out of order delivery of frames between an end-point source and destination pair of switches can occur due to buffering or skew between links. Buffering is particularly significant in multi-hop paths in which frames must traverse more than one switch (“hop”). If the frames take different paths through different switches, and the delays (e.g., due to traffic congestion) through the various switches are not consistent, then the frames may be delivered to the destination out of order. Delivery of frames out of the originating order could also be caused by variations in service times for received frames in the RX queuing logic and for frames to be transmitted in the TX queuing logic. To avoid these effects, it is preferable to ensure that all frames associated with a particular sequence go through the same exact path to maintain “in-order” delivery. Frames for which no ordering requirement is imposed (e.g., frames to different destination devices) may use separate paths, because the ordering does not need to be maintained in this situation.

D. An Embodiment for Dynamic Path Selection with In-order Delivery within Sequence

The process of dynamic path selection in accordance with the present invention enables the even of groups of frames across a predetermined set of paths while maintaining “in-order” delivery of frames within the same sequence. FIG. 6 illustrates a flowchart of the described embodiment of a process 600 of implementing the high-level task application of dynamic path selection with in-order delivery within sequence. To provide further illustration and context when describing the process 600 of FIG. 6, reference will contemporaneously be made to FIGS. 3B and 4.

The present invention modifies the conventional Fibre Channel fabric routing scheme so as to implement the high-level task application of process 600. As previously mentioned, a set of possible paths has been determined for each destination and reflected in an entry to a multiple-field routing table at the initialization of the switch. Moreover, particular fields in the header have been selected for a frame-by-frame process to be carried out in process 600. In the discussion below, assume for simplicity that all the process steps are carried out in an egress port within the switch 400 of FIG. 4 or the switch 312 of FIG. 3B. A person skilled in the art will recognize, however, that the implementation of these steps may vary as to the physical modules where they are carried out.

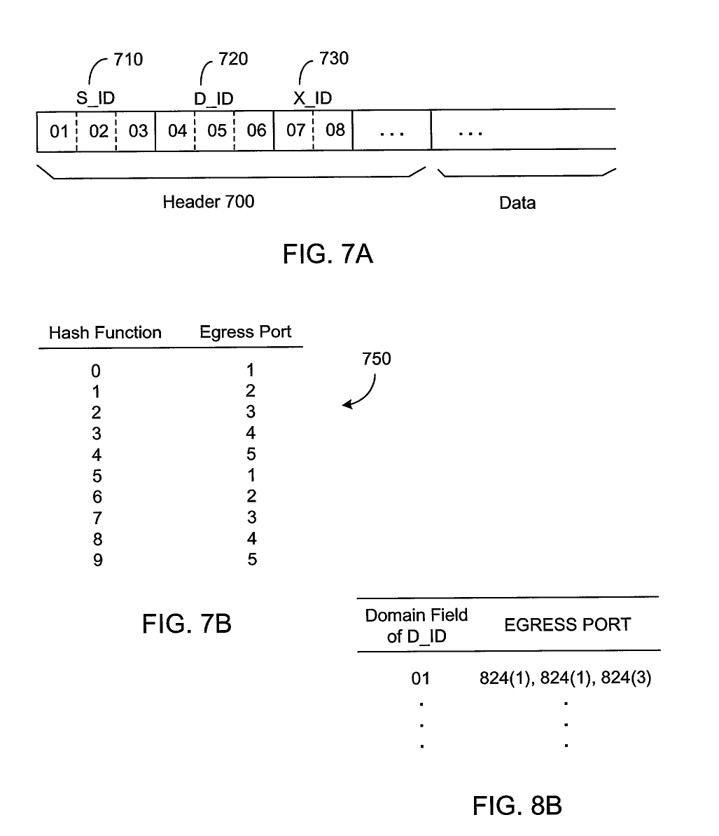

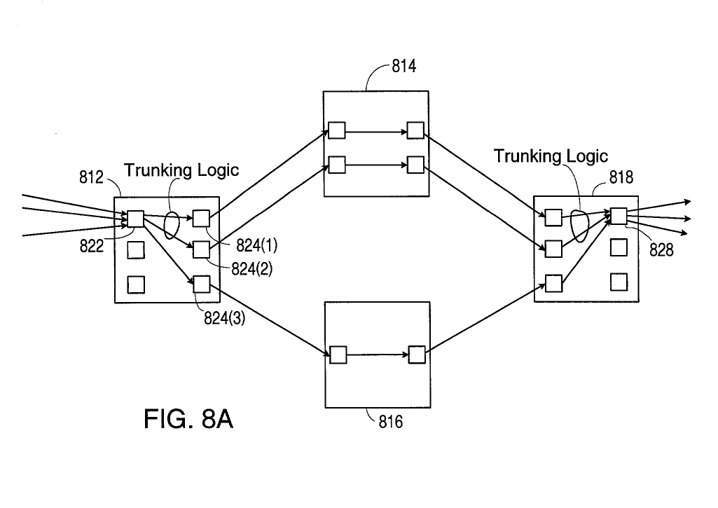

When a frame is received 602 at the ingress port, the first step of the described embodiment of the present invention is to retrieve 604 the information from the preselected fields of the frame header. For example, the switch and the port may have been set up for using the destination identifier (D_ID), source identifier (S_ID), and a single exchange identifier (X_ID) to distinguish sequences for in-order delivery. As illustrated by the example data frame shown in FIG. 7, the various identifiers typically takes the form of a set of numbers (or “words”), each of which may have a particular meaning (e.g. the first word of the D_ID may correspond to the domain). The numbers corresponding to the selected fields can therefore be used to calculate 606 a hash function. The hash function is then used to select 608 a path for the frame and the data frame is forwarded 610 to the port at which the selected path begins.

The hash function serves the simple but important purpose of generating an arbitrary, pseudo-random, number for each frame such that it may be routed through a path according to the arbitrary number, with the statistical effect that frames would be dispersed evenly across all possible paths. In this respect, the form of the hash function is less important than the fact that such a form be defined and programmed in the routing logic during the initialization of the switch. In our example, assume that the hash function is defined to be the sum of all words in D_ID, S_ID and X_ID. Hence, if the three identifiers have the numerical values as shown for the frame header 700 of FIG. 7A, then the calculated hash function will equal 36. If, as is the case in FIG. 3B, there are only two possible paths for the frames going through switch 312 and are destined for 318, then a simple rule for routing the frame could be: use path 352, 344, 356 if the hash function is an odd number, but use path 354, 346, 358 if the hash function is an even number. However, if more paths, and corresponding egress ports, are available, then a different rule may be more appropriate. For our example, consider an alternative hash function which is defined as only the last digit of the sum of all the words. The result may take one of the numbers from 0 to 9. FIG. 7B shows a chart 750 which illustrates for our example one way to select an egress port out of five possible choices listed in the multiple fields 525 of the corresponding entry to the routing table.

Finally, note that the form of the hash function as well as the choice of frame header fields to be used in the computation of the hash function should remain flexible. Hence, for example, the firmware or hardware may be responsible for computing the hash function, but the form of the hash function and the choice of header fields to be utilized may be supplied independently by the routing software. In this way, one has the flexibility to deal with changes in the fabric topology or in the in-order delivery requirement (e.g., when the fiber channel high-level network protocol is updated) while at the same time achieving fast transmission of data since each frame is processed only by the hardware.

E. Conclusion

In sum, the present invention allows a communication network system to manage data flow through a dynamic path selection process that guarantees in-order delivery of data frames for data sequences, such as Fibre Channel exchanges, that require their respective data frames to remain in-order as these frames arrive at their respective destination. To allow more efficient use of the available bandwidth through multiple paths in the fabric, data frames that do not require in-order delivery are generally delivered out-of-order. It is therefore an important aspect of the present invention that data frames requiring in-order delivery be distinguished from frames not having such requirement. This is accomplished in a frame-by-frame analysis, preferably carried out efficiently by firmware or hardware, as illustrated for one embodiment in FIG. 6.

Another important aspect of this invention is the utilization of the software to establish the “environment” for the frame-by-frame analysis at the initialization stage. For example, before any data frame is routed, the routing software may determine sets of paths through the fabric that can be used by data frames destined for different targets and accordingly set up the entries in a routing table. The routing software may even be empowered each time a switch is initialized to select an appropriate hash function, as well as the header fields of the data frames to be used, for the firmware or hardware to perform the frame-by-frame analysis.

Additional functionality can be included in different embodiments of the present invention. For example, a weighting function between multiple paths may be

1. A method for in-order delivery of data within sequence from a first communication device to a second communication device in a system including a fabric, the method comprising:
receiving at the first communication device a data frame destined for the second communication device;
retrieving sequence information from said data frame, wherein data frames with the same sequence information require in-order delivery;
utilizing said sequence information to calculate a hash function; and
based on the calculated hash function, selecting one of a predetermined set of paths through the fabric connecting the first communication device to the second communication device.

2. The method of claim 1, further comprising:
routing said data frame over the selected path to the second communication device.

3. The method of claim 1, wherein the fabric is comprised of a plurality of interconnected Fibre Channel switches.

4. The method of claim 1, wherein the first communication device is a Fibre Channel switch.

5. The method of claim 1, wherein the second communication device is an end device in communication with the fabric.

6. The method of claim 1, wherein said sequence information includes information in at least one pre-selected field of a header of said data frame.

7. The method of claim 6, wherein said hash function equals to the last digit of the sum of all values in said at least one pre-selected header field included in said sequence information.

8. The method of claim 1, wherein said sequence information includes information in a source identifier field and a destination identifier field of a header of said data frame.

9. The method of claim 1, wherein said sequence information includes information in at least one exchange identifier field of a header of said data frame.

10. The method of claim 1, wherein each of said predetermined set of paths connecting the first communication device to the second communication device comprises a series of links between ports on adjacent communication devices.

11. The method of claim 1, wherein each of said predetermined set of paths satisfies specified requirements on availability and on cost efficiency.

12. The method of claim 1, wherein selecting one of a predetermined set of paths further comprises:
selecting one of a plurality of fields in an entry of a multiple-field routing table, wherein each field in the entry corresponds to one of said predetermined set of paths.

13. The method of claim 12, wherein every value of the hash function is associated with a field in the entry of said multiple-field routing table.

14. The method of claim 12, further comprising:
forwarding said data frame to a transmit port within the first communication device based on said selected field in the entry of said multiple-field routing table, wherein said selected path originates at said transmitting port.

15. A method for in-order delivery of data within sequence from a first communication device to a second communication device in a system including a fabric, the method comprising:
receiving at the first communication device a plurality of data frames destined for the second communication device;
retrieving sequence information from each of said plurality of data frames;
based on said retrieved sequence information, categorizing said plurality of data frames into a plurality of sequences, wherein each of said plurality of sequences requires in-order delivery; and
selecting for each of said plurality of sequences one of a predetermined set of paths through the fabric connecting the first communication device to the second communication device.

16. The method of claim 15, further comprising:
routing said plurality of data frames over said predetermined set of paths, wherein all data frames belonging to a sequence use said selected path for said sequence.

17. The method of claim 15, wherein said sequence information from each of said plurality of data frames includes information in at least one pre-selected field of a header of said data frame.

18. The method of claim 15, wherein each of said plurality of sequences includes data frames with a same source device and a same destination device.

19. The method of claim 15, wherein each of said plurality of sequences includes data frames within a same Fibre Channel exchange.

20. The method of claim 15, wherein categorizing the plurality of data frames into a plurality of sequences further comprises:
associating an arbitrary number with all data frames corresponding to each of said plurality of sequences.

21. The method of claim 20, wherein associating an arbitrary number with all data frames corresponding to each of the plurality of sequences further comprises:
associating an arbitrary number with each set of sequence information.

22. The method of claim 21, wherein said arbitrary number corresponding to each set of sequence information is a hash function calculated from said set of sequence information.

23. The method of claim 20, wherein selecting for each of the plurality of sequences one of a predetermined set of paths further comprises:
selecting, for each of said plurality of sequences, one of a predetermined set of paths based on said arbitrary number associated with the sequence.

24. The method of claim 15, wherein selecting for each of the plurality of sequences one of a predetermined set of paths further comprises:
selecting, for each of said plurality of sequences, one of a plurality of fields in an entry to a multiple-field routing table, wherein each field in said entry corresponds to one of said predetermined set of paths.

25. A method for in-order delivery of data within sequence from a first communication device to a second communication device in a system including a fabric, the method comprising:
identifying at least one header field as the basis for categorizing data frames into a plurality of sequences, wherein each sequence requires in-order delivery;
selecting a set of paths through the fabric connecting the first communication device to the second communication device; and
constructing an entry of a multiple-field routing table, wherein each field in the entry corresponds to one of said selected set of paths and wherein at least one field is associated with each of said selected paths.

26. The method of claim 25, further comprising:
upon receiving a data frame at the first communication device, routing the data frame to the second communication device based on header information of the data frame in said at least one header field, and the entry of said multiple-field routing table.

27. The method of claim 26, wherein routing the data frame to the second communication device further comprises the steps performed at the first communication device of:
retrieving said header information from the data frame;
utilizing said header information to calculate a hash function;
choosing one of said selected paths based on said calculated hash function and said entry of said multiple-field routing table; and
routing the data frame over said selected path to the second communication device.

28. The method of claim 25, wherein:
each of said plurality of sequences includes data frames with a same source device and a same destination device, and
said at least one header field includes a source identifier field and a destination identifier field.

29. The method of claim 25, wherein:
each of said plurality of sequences includes data frames within a same Fibre Channel exchange, and
said at least one header field includes an originator exchange identifier field and an responder exchange identifier field.

30. The method of claim 25, wherein selecting a set of paths through the fabric connecting the first communication device to the second communication device further comprises:
selecting a set of paths among all paths through the fabric connecting the first communication device to the second communication device based on specified requirements on availability and on cost efficiency.

31. The method of claim 25, wherein each of a subset of said selected paths is associated with more than one field in the entry of said multiple-field routing table.

32. The method of claim 31, wherein each path within the subset has higher bandwidth than any of the selected paths outside the subset.

33. The method of claim 25, wherein each of a subset of said selected paths is associated with a weighting factor.

34. A switch for in-order delivery of data within sequence through a fabric from a first communication device to a second communication device, the system comprising:
a data reception module for receiving from the first communication device a plurality of data frames destined for the second communication device;
a sequence identification module for retrieving sequence information from each of said plurality of data frames and for utilizing said retrieved sequence information to categorize said plurality of data frames into a plurality of sequences, wherein each of said plurality of sequences requires in-order delivery;
a path selection module for selecting for each of said plurality of sequences one of a predetermined set of paths through the fabric connecting the first communication device to the second communication device; and
a data transmission module for routing said plurality of data frames over said predetermined set of paths, wherein all data frames belonging to a sequence use said selected path for the sequence.

35. The switch of claim 34, wherein the sequence identification module further comprises:
a computation module for calculating a hash function from sequence information retrieved from each of said plurality of data frames; and
a data association module for associating said hash function calculated from said sequence information of each of said plurality of data frames with one of said plurality of sequences.

36. The switch of claim 35, wherein the path selection module further comprises:
a path assignment module for assigning one of a predetermined set of paths to each of said plurality of sequences based on said calculated hash function associated with said sequence.

37. The switch of claim 34, wherein the path selection module further comprises:
a multiple-field routing table including an entry for said selected set of paths, wherein each field in said entry corresponds to one of said selected set of paths and wherein at least one field is associated with each of said selected paths; and
a field assignment module for assignment one of said multiple fields of said entry to said multiple-field routing table to each of said plurality of sequences.

38. The switch of claim 34, further comprising:
a preprocessing module for identifying at least one header field as the basis for the categorization of data frames into a plurality of sequences, and for selecting a set of paths through the fabric connecting the first communication device to the second communication device.

39. A Fibre Channel network comprising:
a source device for providing a plurality of data frames comprising a sequence, each of said data frames including sequence information;
a target device for receiving said plurality o data frames from said source device;
a Fibre Channel fabric connecting said source and target devices, said Fibre Channel fabric including:
a first switch having an input coupled to said source device and having two outputs;
second and third switches, each of said second and third switches having an input coupled to one of said first switch outputs and having an output;
a fourth switch having two inputs, each coupled to one of the outputs of said second and third switches and having an output coupled to said target device, so that a sequence from said source device to said target device can be transmitted through either of said second or third switches,
wherein said first switch includes:
a data reception module for receiving from said source device a plurality of data frames destined for said target device;
a sequence identification module for retrieving sequence information from each of said plurality of data frames and for utilizing said retrieved sequence information to categorize said plurality of data frames into a plurality of sequences, wherein each of said plurality of sequences requires in-order delivery;
a path selection module for selecting for each of said plurality of sequences one of a predetermined set of paths through the fabric connecting said source device to said target device; and
a data transmission module for routing said plurality of data frames over said predetermined set of paths, wherein all data frames belonging to a sequence use said selected path for said sequence.

40. The Fibre Channel network of claim 39, wherein the sequence identification module further comprises:
a computation module for calculating a hash function from sequence information retrieved from each of said plurality of data frames; and
a data association module for associating said hash function calculated from said sequence information of each of said plurality of data frames with one of said plurality of sequences.

41. The Fibre Channel network of claim 40, wherein the path selection module further comprises:
a path assignment module for assigning one of a predetermined set of paths to each of said plurality of sequences based on said calculated hash function associated with said sequence.

42. The Fibre Channel network of claim 39, wherein the path selection module further comprises:
a multiple-field routing table including an entry for said selected set of paths, wherein each field in said entry corresponds to one of said selected set of paths and wherein at least one field is associated with each of said selected paths; and
a field assignment module for assignment one of said multiple fields of said entry to said multiple-field routing table to each of said plurality of sequences.

43. The Fibre Channel network of claim 39, further comprising:
a preprocessing module for identifying at least one header field as the basis for said categorization of data frames into a plurality of sequences, and for selecting a set of paths through the fabric connecting said source device to said target device.
